(19) United States
(12) Patent Application Publication
(10) Pub. No.: US 2019/0084256 A1
(43) Pub. Date: Mar. 21, 2019

(54) Systems and Methods for the Manufacture of Vertically Oriented Fluted Multiwalls

(71) Applicant: Oren SITTON, Ness-Ziona (IL)

(72) Inventor: Oren SITTON, Ness-Ziona (IL)

(21) Appl. No.: 15/708,263

(22) Filed: Sep. 19, 2017

(51) Int. Cl. B29D 24/00

(52) U.S. Cl. CPC B29D 24/005; B29L 2031/60

(57) ABSTRACT

Methods and machine for manufacturing vertically oriented core of multiwalls and multiwalls comprising such core. Multiwalls or cores of multiwalls with transversely oriented flutes in their core are sliced perpendicularly relative to the axis of rotation of the flutes. The slices are bent relative to the origin multiwall or core, packed together, welded or fused or mechanically pressed to each other and their top and bottom surfaces leveled to provide a vertically oriented shortened flutes that form the core. The top and bottom surfaces of the core are then laminated. Machine configurations are also provided for continuous manufacturing of vertically oriented cores of multiwalls.

### TECHNICAL FIELD

The present invention pertains to means and method for manufacturing multiwalls. More particularly, the present invention pertains to systems and methods for converting transversely to vertically oriented cores of multiwalls.

### BACKGROUND OF INVENTION

Multiwalls are commonly used in the construction of different types of plastic furniture. Their basic structure is sandwich having skin surfaces on top and bottom that enclose a core in the middle. The core is usually formed of transversely extending flutes along the length or width of the multiwall relative to the top and bottom skins. The core provides the multiwall the strength to bear loads, particularly, when used in shelf systems, closets, cupboards and the like. To increase the strength of multiwalls the core is oriented upright relative to the skins. Several technologies have been developed for manufacturing a core that is 90° oriented relative to the top and bottom skins. These technologies essentially manufacture hollow vertical poles on the bottom surface then laminated from top with the upper surface, which evidently leads to complicated, time consuming and expensive process, resulting in a more expensive product.

There is, therefore, a need to provide cost-effective, relatively simple, faster and cheaper method for forming vertically oriented core of multiwalls and multiwall comprising such core.

Further, there is a need to provide relatively simple means for manufacturing such vertically oriented core of multiwalls and multiwall comprising such core.

The present invention responds to these objectives as detailed in the following description with exemplary reference to the accompanying drawings.

### SUMMARY OF INVENTION

In one aspect, the present invention provides a method of manufacturing vertically oriented core of multiwall and multiwall comprising such core. The manufacture of multiwalls with a core that contains vertical flutes is more complicated and time consuming than a core with a smaller number of transversely oriented flutes. This is due to the need to produce a larger number of shortened vertical flutes relative to a smaller number of transverse flutes to cover the same area. The method of the present invention essentially uses available materials, constructions and devices that make it technologically simple and cost-effective relative to current technologies to obtain the same product.

Therefore, the method comprises a method for the manufacture of vertically oriented multiwall core, namely a core of a multiwall that comprises vertically oriented flutes relative to top and bottom skins that cover them. Such method comprises the following:

(a) providing fluted multiwall or fluted core of multiwall that comprises at least one array of transversely oriented flutes;

(b) providing at least one cutting means configured for slicing the array of transversely oriented flutes of the fluted multiwall or fluted core of multiwall;

(c) placing the cutting means in contact at selected distance from first longitudinal edge of the fluted multiwall or fluted core of multiwall;

(d) cutting through a selected thickness of the fluted multiwall or fluted core of multiwall with the cutting means;

(e) generating a slice of the fluted multiwall or fluted core of multiwall;

(f) folding the slice relative the fluted multiwall or fluted core of multiwall or a slice previously cut off from said fluted multiwall or fluted core of multiwall;

(g) packing the folded slice with the previous folded slice;

(h) repeating steps (c)-(g) until reaching second longitudinal edge parallel the first longitudinal edge of the fluted multiwall or fluted core of multiwall.

Optionally, adjacent slices are heat-welded or heat-fused to each other after folding. Optionally, adjacent slices are arranged in contact with each other by pressing them together, for example with a press applied on the two extreme slices of the pack of slices formed.

The folding of the slices after cutting may be done 90° clockwise relative to the currently forming vertically oriented multiwall, 90° counterclockwise relative to the previously cut slice or 180° clockwise relative to the origin multiwall. In the last option of folding, the slices are packed one above the other in stack formation, where the last slice cut is positioned on top of the stack

To form the multiwall of the present invention, further step is required of thermal treatment for leveling the open bases of the shortened vertical flutes formed. A further step of laminating the top and bottom surfaces of the core completes the process of manufacturing the multiwall. Therefore, the method as detailed above further comprises:

(i) stabilizing the upper and lower surfaces of the vertically oriented core multiwall; and

(j) covering the upper and lower surfaces of the vertically oriented core multiwall.

In one particular non-limiting embodiment, the slicing of the origin multiwall with transversely oriented flutes half- or part-thickness essentially creates accordion configuration of the slices that may be folded 90° relative each other clockwise or counterclockwise around the newly formed axis between them. To achieve that the slicing may be carried out with at least one knife that cuts through the thickness of the origin multiwall and along the longitudinal length perpendicular to the flutes between the first and second transverse edges of the origin multiwall. This slicing is done at a selected distance from the longitudinal edges of the multiwall or previous cuts. Thus an array of slices is obtained that may be folded one upon the other in an accordion configuration. The slicing may be done down to the bottom layer of the multiwall, leaving only the bottom layer that connects between adjacent slices and stretched when folding them.

In another particular embodiment, the slices are folded 180° relative to the origin multiwall in stack formation, where they are packed one above the other, the last slice being on top. The multiwall is cut down to its bottom layer that connects between adjacent slices and stretched when folding them.

When the slicing is carried out in only one direction from one surface to the opposite surface, then the slices may be completely cut and separated from the origin multiwall or partly cut down to the bottom layer of the origin multiwall and folded 180° as described above. The slices may be folded by rotating them 90° clockwise one over the other, then welded to each other, for example by heat-welding or heat-fusion, or mechanically pressed together, thereby forming the core of vertically oriented shortened flutes of the multiwall of the present invention. Slicing in opposite directions from the top and bottom surfaces may be done for partial slicing down to the bottom layer of the origin multiwall, keeping the slices connected to each other. In the general case, a selected horizontally measured distance is set between the cutting means placed on each surface of the origin multiwall. One cutting means, for example a roller knife or a blade, cuts through the multiwall in opposite direction relative the other cutting means. This opposite cutting is required to enable the folding of adjacent slices over each other in 90° alternating clockwise and counterclockwise directions, where the slices are still connected to each other in alternating upper and lower connecting lines.

The number of cutting means may be one or more. In one particular non-limiting example, when the origin multiwall is mounted, for example, on conveyor belt, then it is transported relative to a cutting means placed in fixed position. The cutting means is moved down to cut a slice off of the multiwall, then moved up and the multiwall transported the distance selected for creating another slice. The slicing repeats itself until reaching the longitudinal edge of the multiwall.

In an alternative, cog-wheel with blades between neighbor teeth constantly rolls over the surface of the multiwall or core of multiwall, enabling the blades to cut through its thickness and throughout the length. For example, top and bottom cog-wheels with blades between their teeth may be used to continuously cut slices off from a multiwall or core of multiwall traveling between them. The distance between the cog-wheels provides sufficient space to allow a multiwall or core of multiwall to pass through while being cut part-, half- or full-way through their thickness.

In still another alternative, a plurality of cutting means may simultaneously cut through the thickness of the origin multiwall either completely or partially from the two surfaces.

The folding step may be simultaneous with the cutting step, where every slice formed is folded over a previously cut slice and welded, fused or pressed to it, for example by heat-welding or heat-fusion or with use of a press, while a new slice is formed. Thus, a continuous process for manufacturing vertically oriented multiwalls or cores of multiwalls is obtained.

Stabilizing with thermal treatment for leveling the top and bottom surfaces of the core and covering or lamination are done when completing the slicing and folding as described above. In particular, the covering or lamination may be carried out by heat-welding, heat-fusion or gluing.

In one particular embodiment, the covering step is done with extruded sheets, where each sheet comprises at least two layers, where the layers are distinguished one from the other according to their MFIs (Melt Flow Index).

The covering with such sheets that form the covers comprises:

placing the covers on the upper and lower surfaces of the slices formed from cutting the transversely oriented flutes of the fluted multiwall or fluted core of multiwall;

applying heating means over these covers; and

heating the covers.

The heating is configured to turn at least part of the bottom layer of the covers to adhesive, where that adhesive bonds the laminates to the upper and lower surfaces of the slices. It should be noted that the MFI of the bottom layer is sufficient to at least partly melt and bond it to the slices.

In one particular embodiment, the upper and lower surfaces of the slices are wavy, indented and/or textured, where the adhesive formed from the bottom layer of the cover is configured to form mechanical and/or physical bond with the upper and lower surfaces of the slices. The top layer of the cover forms the skin of the multiwall and is bonded to the multiwall core upon melting the adhesive that is obtained from the bottom layer of the cover.

In one particular embodiment, the bottom layer of the cover is foamed with increased free volume within to enable better spreading on and adhering to the top and bottom surfaces of the slices.

The method of manufacturing the multiwall with vertically oriented shortened flutes is not limited to a particular shape of flutes. Particular non-limiting examples of cross sections of the flutes in the origin multiwall may be selected from circular, rectangular, pentagonal, hexagonal, octagonal, parallelogram and diamond. The number of layers of flutes in the origin multiwall may also be more than one. Such example is illustrated in FIGS. 10A-12C and 15 of the present application. Further, combinations of flutes with different cross-sections are also contemplated within the scope of the present invention (see FIG. 15).

The material from which the origin fluted multiwall or fluted core of multiwall is made is also not limited. In particular, the material may be selected from polypropylene (PP), polyethylene (PE), polyethylenterphthalate (PET), polystyrene (PS) and polycarbonate (PC).

In another aspect, the present invention provides a machine configured for manufacturing vertically oriented multiwall core, where the system comprises:

conveyor belt configured for conveying fluted multiwall or fluted core of multiwall that comprises at least one array of transversely oriented flutes;

at least one cutting means configured for cutting through the fluted multiwall or fluted core of multiwall; and

positioning means configured for positioning the at least one cutting means in contact with upper and lower surfaces of the fluted multiwall or fluted core of multiwall.

Further, the machine may comprise:

thermal treatment means configured for heat-welding or heat-fusing neighbor slices cut off from the origin multiwall to each other;

pressing means configured for pressing the slices to each other;

thermal treatment means configured for leveling the upper and lower surfaces of the newly formed core; and

laminating means configured for laminating these upper and lower surfaces.

In still another aspect, the present invention provides vertically oriented multiwall manufactured according to the method or with the machine as described above.

The following will describe particular and non-limiting examples of the present invention with exemplary reference to the drawings without departing from the scope and spirit of the present invention.

### BRIEF DESCRIPTION OF THE DRAWINGS

FIGS. 1A-C schematically illustrate different perspectives of horizontally fluted multiwall.

FIGS. 2A-B schematically illustrate first step in a process manufacturing fluted multiwall.

FIGS. 3A-B schematically illustrate another first step a process of manufacturing vertical fluted multiwall.

FIGS. 4A-B schematically illustrate second step in a process of manufacturing vertical fluted multiwall.

FIGS. 5A-B schematically illustrate third step in a process of manufacturing vertical fluted multiwall.

FIGS. 6A-C schematically illustrate last step in a process of manufacturing vertical fluted multiwall and the multiwall manufactured.

FIGS. 7A-C schematically illustrate different perspectives of hexagonal fluted multiwall.

FIGS. 8A-B schematically illustrate first step in a process of manufacturing vertical hexagonal fluted multiwall.

FIGS. 9A-D schematically illustrate second to last steps in a process for manufacturing vertical hexagonal fluted multiwall.

FIGS. 10A-C schematically illustrate different perspectives of double-layer hexagonal fluted multiwall.

FIGS. 11A-C schematically illustrate the steps in a process for manufacturing vertical double-layer hexagonal fluted multiwall.

FIGS. 12A-C schematically illustrate different perspectives of the vertical double-layer hexagonal fluted multiwall manufactured.

FIGS. 13A-E schematically illustrate and summarize the steps of manufacturing vertical fluted multiwall.

FIG. 14 schematically illustrates a particular machine for manufacturing vertical fluted multiwall.

FIG. 15 illustrates triple layer core of transversely oriented multiwall with combination of cross-sections of its flutes.

FIG. 16 illustrates a particular procedure for covering the slices.

### DETAILED DESCRIPTION OF THE DRAWINGS

The following describes different aspects of the method and machine of the present invention and in further detail and for demonstration purposes without departing from the scope and spirit of the present invention. It is understood that the configuration(s) and mode(s) of operation described herein do not limit the present invention to the particulars detailed below.

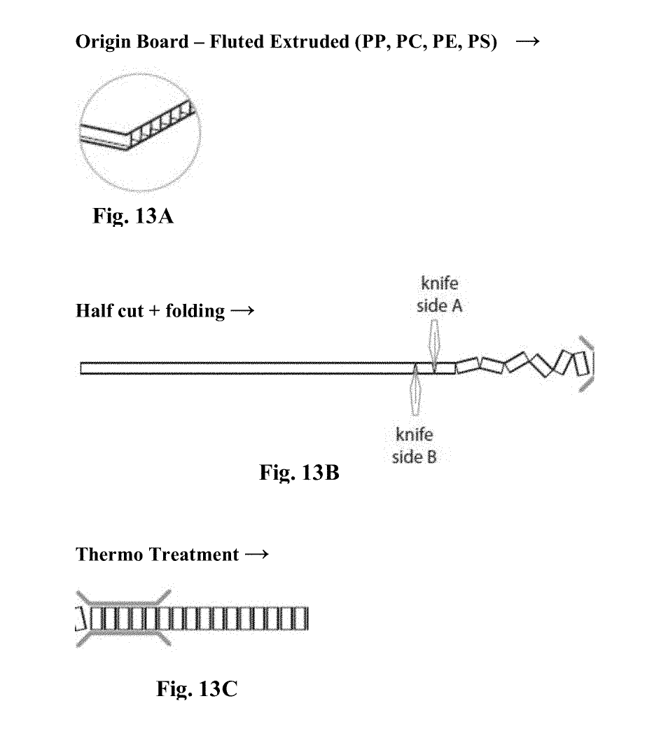

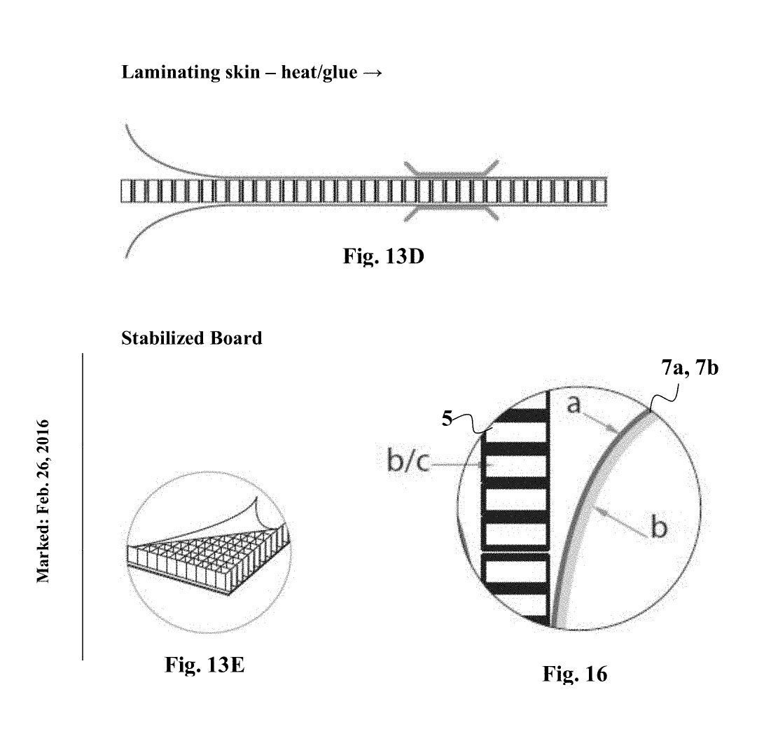

FIGS. 13A-E summarizes the process for manufacturing vertically oriented core and multiwall comprising it according to the present invention. A fluted core of a multiwall is first provided (FIG. 13A) with a transversely oriented array of flutes, namely the flutes that support the top and bottom skins of a multiwall stretch along its width. The core of the multiwall is vertically cut to selected depth through the thickness of the multiwall core and along its length with a plurality of cuts at selected distance from each other. As illustrated in FIG. 13B, a plurality of cutting means may simultaneously cut through the thickness of the core of a multiwall in parallel lines, where each two adjacent cuts are made from opposite sides to enable the folding step of the slices formed fluent and simultaneous with the cutting step. The third step in the process involves heat treatment of the top and bottom surfaces of the slices (FIG. 13C) to heat- or fuse-weld the slices to each other or press them together and form unified smooth surfaces for laminating the top and bottom skins as illustrated in FIG. 13D. The product of the process, which is vertically oriented core multiwall, is shown in FIG. 13E.

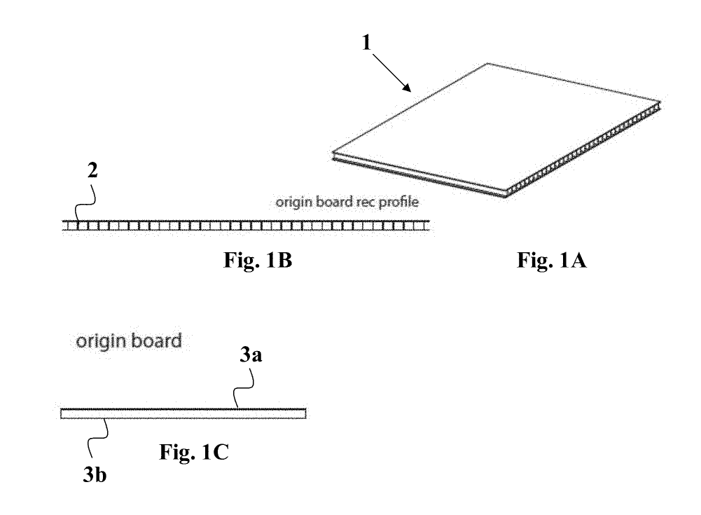

FIGS. 1 through 5 illustrate the schematics of forming vertically oriented core and multiwall thereof in further detail. In FIGS. 1A-C a transversely oriented core of a multiwall (1) is illustrated in different perspectives. The flutes (2) are perpendicular to the top and bottom skins (3a, 3b), adjacent each other, and extend along the width of the multiwall.

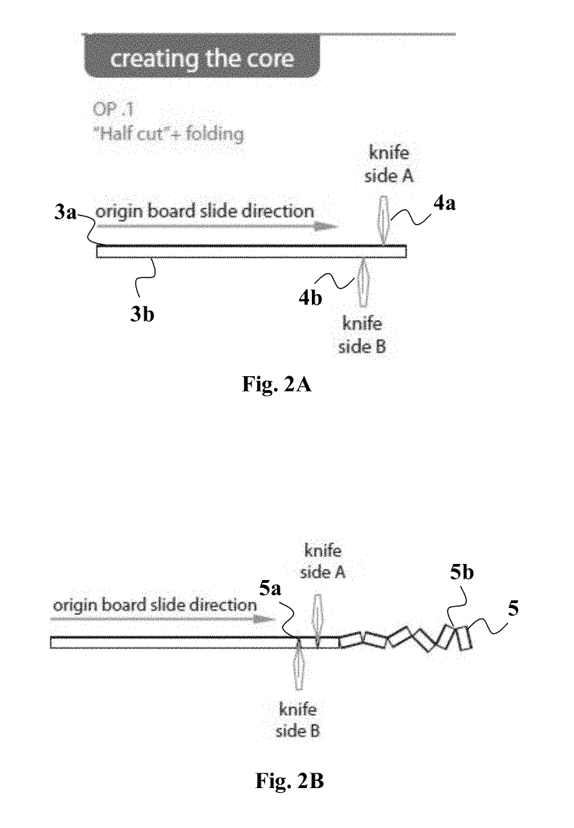

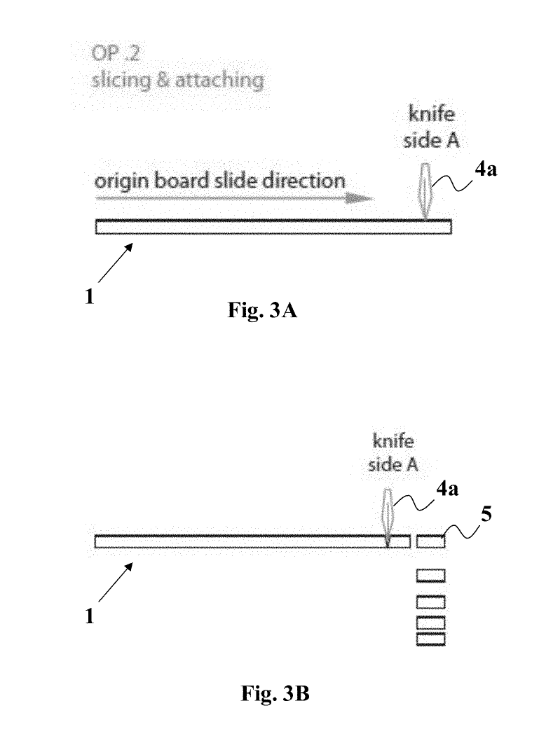

The first step of converting transversely to vertically oriented core of multiwall can be carried out in two exemplary methods as illustrated in FIGS. 2A-2B and 3A-3B. Knives or blades (4a, 4b) are simultaneously placed in contact with the top and bottom surfaces of the core or skins (3a, 3b) for that matter and at selected distance between their points of contact. The knives/blades (4a, 4b) cut through the depth of the core/multiwall a selected depth (5a), for example, down to a bottom layer of the origin multiwall, that enables folding the slices (5) formed in the next step (shown in FIG. 2B). In one option, after reaching the desired depth, the knives/blades (4a, 4b) extend the cut formed at the point of entry along the length of the core or multiwall. In another option, the blade is at least the width of the width of the origin multiwall, so the slice is formed with one cut. As a result, a slice is cut off from the entire row of flutes (2). The knives/blades (4a, 4b) then define another distance between them that is adjacent the former distance, and repeat the cutting process forming another slice (5). Each slice (5) is folded 90° around the newly formed axis represented by (5a) relative to the original axis of rotation of the flutes, where each two adjacent slices are folded one in clockwise direction, the other in counterclockwise direction in accordion fashion. Alternatively, the slices are folded 180° towards the origin multiwall in stack formation as described above. As shown in FIG. 2B the steps of slicing and folding can be carried out continuously with each other. Namely, the slices formed are folded 90° or 180° while knives/blades (4a, 4b) continue to cut new slices. The particular example in FIG. 2B shows that the core/multiwall advances a selected distance towards the folding area while the knives/blades (4a, 4b) stay in fixed position relative to it. Alternatively, the core/multiwall may be fixed in place, while the knives/blades (4a, 4b) move along its width a selected distance each time. In a third option, both the knives and multiwall or core of multiwall move one relative to the other in opposite directions.

FIGS. 3A-B exemplify variation of the method of forming a vertically oriented core of multiwall. In this method, the slices (5) are entirely cut off and separated from the core/multiwall (1). Accordingly, only one knife or blade (4a) is required. The slices (5) are collected and packed in vertical position relative to their axis of rotation and top and bottom surfaces of the skins that will cover them. Thermal treatment and lamination follow the cutting and folding steps.

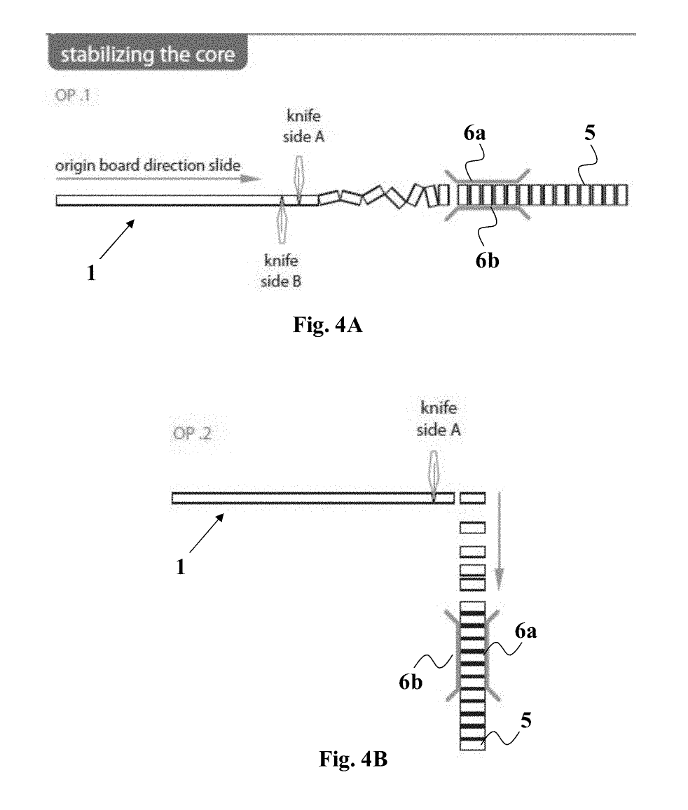

FIGS. 4A-B illustrate the following step of stabilizing the core of arrays of vertical shortened flutes adjacent each other. Presses (6a, 6b) apply isostatic pressure on the open ends of the slices of flutes (5) from parallel opposite sides, thereby leveling and smoothing the surfaces for the following step of covering or lamination and heat- or fuse-welding adjacent slices to each other or the slices are mechanically pressed to each other.

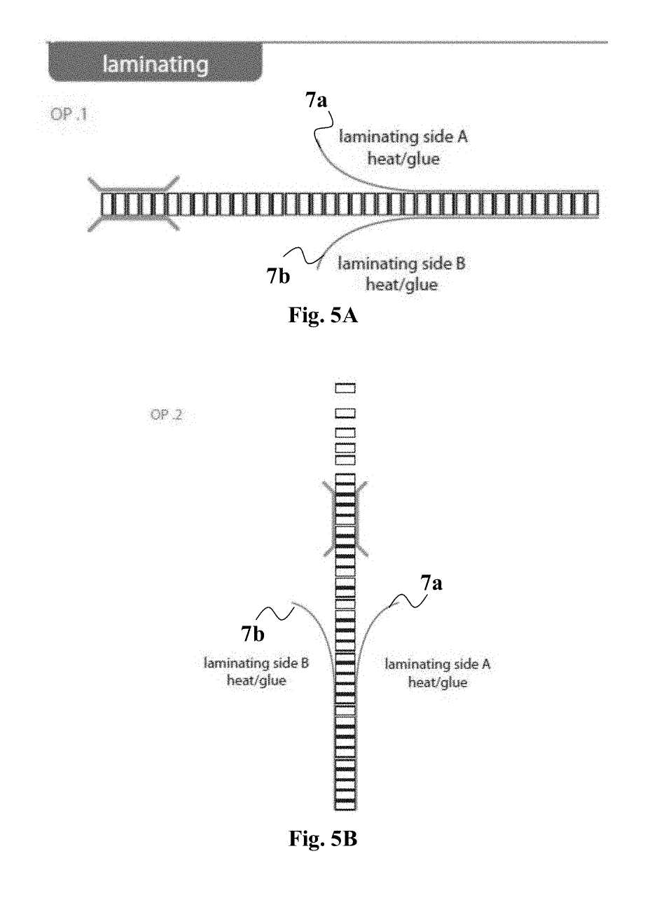

FIGS. 5A-B show the final step of laminating the slices (5) according to each of the cutting versions presented in the previous Figs. For each, the lamination or covering is essentially the same, closing the open ends of the slices (5) with laminates (7a, 7b) attached to them with heat-welding, heat-fusion or gluing. The core obtained may then be used for different purposes and uses by overlaying different covers on it.

FIG. 16 schematically illustrates a particular procedure for covering the slices (5) with covers (7a, 7b). Particularly, covers (7a, 7b) are composed of two layers (a, b) that form an extruded sheet, where each layer has a different MFI (Melt Flow Index) relative to the other layer. Using extrusion to form the covers (7a, 7b) enables the adhesion of the two layers (a, b) to each other. When contacting the covers (7a, 7b) to the outer surfaces of the slices (5) core and applying heat, layer (a), which is in direct contact with the slices (5) melts over their top ends and functions as adhesive to bond the covers (7a, 7b) to the slices (5). Now, due to the difference in MFIs of the two layers (a) and (b), layer (a) absorbs the heat and melts, where layer (b) remains intact and forms the outer surface of the vertical multiwall. The melted layer (a) may bond to the outer surfaces of the slices (5) in any way known for adhesives, for example mechanical by infiltrating into crevices and holes in the surface of the slices (5) and/or increasing friction between the cover and surface of the slices and/or physical by generating physical bonds between the adhesive molecules and the molecules of the material of the slices (5) at their surface.

The (b/c) indication in FIG. 16 signifies the eventual result, where layer (a) no longer exists in the form of a continuous layer with defined dimensions but rather as adhesive layer that connects between layer (b) that forms the skin of the multiwall structure, and the surface of the slices (5). The structure of the multiwall, thus, is now defined by the slices (5) core and the outer layer (b) of the extruded sheets, i.e., covers (7a, 7b).

In a particular embodiment, the bottom surface of the extruded sheet, that is the bottom surface of layer (a) that comes in contact with the surfaces of the slices (5), is not smooth. For example, such surface may be wavy, indented and/or textured to match waviness, indentation and/or texture of the surfaces of the slices (5) that result in the process of cutting the transverse flutes to form perpendicular flute core. In such case, layer (a) may better function as adhesive upon melting and optionally slightly pressing, due to the plurality of crevices and holes at the slices surfaces into which the adhesive can infiltrate and form a stronger bond, mechanical and/or physical.

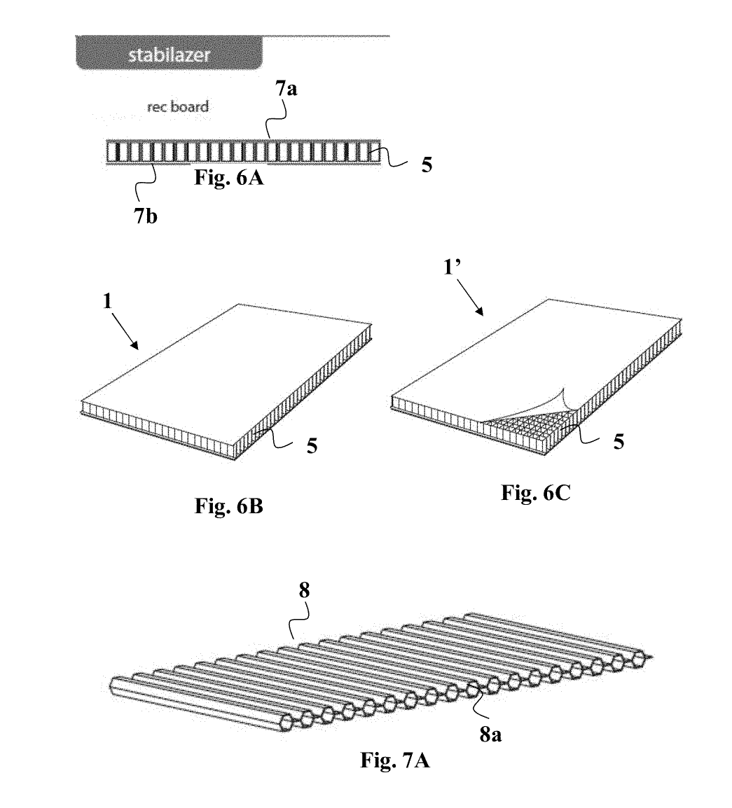

The vertically oriented multiwall core (1′) is shown in different perspectives in FIGS. 6A-C. The slices or arrays (5) of now vertically oriented shortened flutes are packed one next to the other, welded or fused together ordered in place after removing mechanical pressure applied on the slices, and covered with top and bottom covers (7a, 7b). The multiwall core (1′) formed is, therefore, obtained in a relatively simple and cost-effective process without complex technologies or machinery.

Heat may be applied also to relieve tension built in the core as in the cutting and folding process.

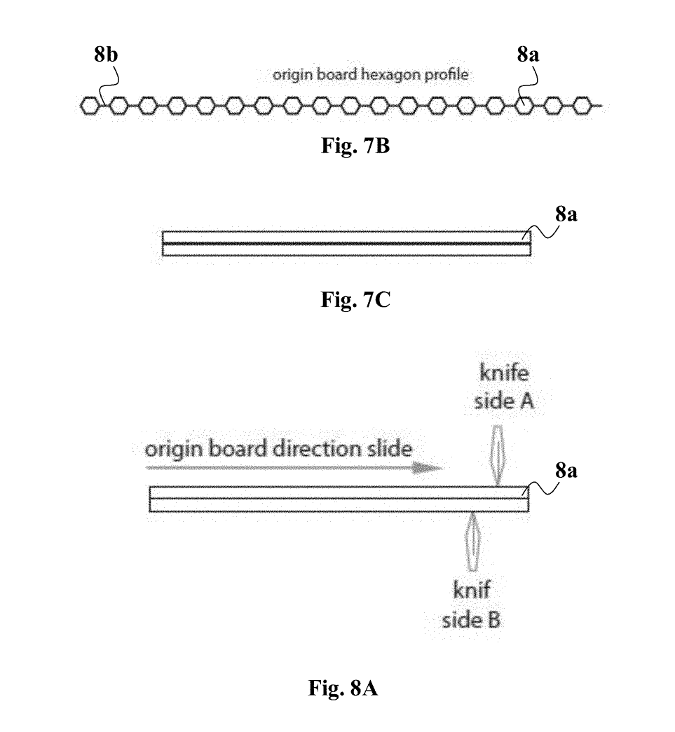

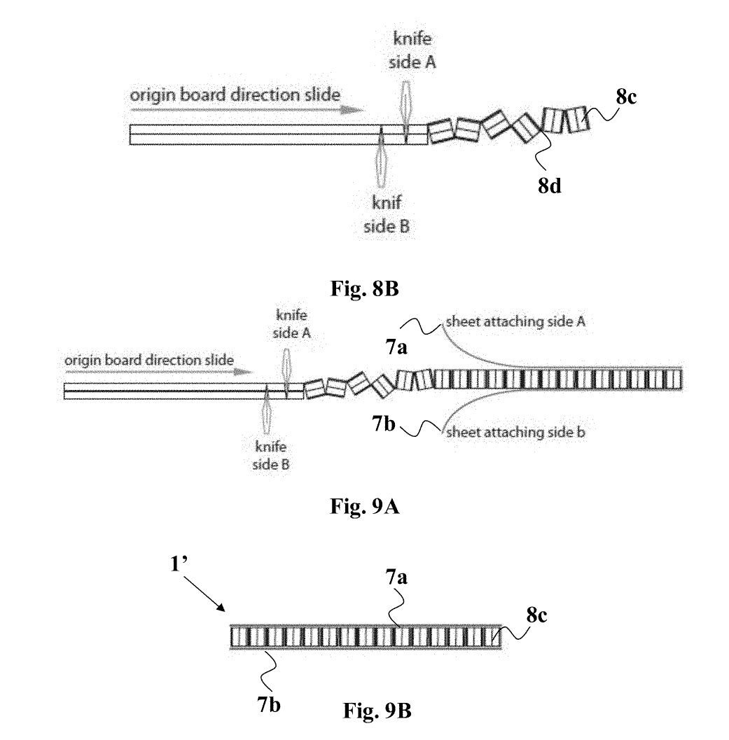

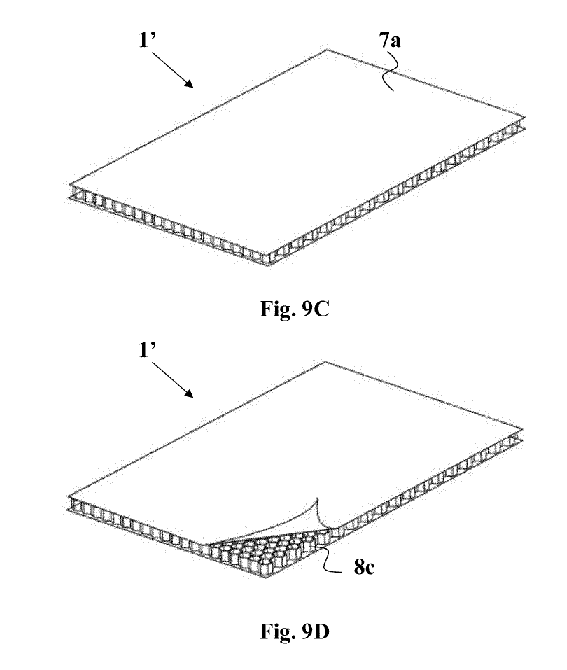

Vertically oriented core multiwall can be essentially done with any shape of flutes and/or any form of packing. FIGS. 7A-9D demonstrate the same process described above for flutes with hexagonal cross section (8a). Here also the array of flutes is sliced to multiple slices. The gap between adjacent flutes (8a) contains a horizontal film (8b) connecting between them, which is cut and separated from the array (8) in the slicing step. The slices (8c) formed may remain connected to each other in an axis of rotation (8d) and rotated 90° clockwise or counterclockwise to form adjacent arrays of shortened vertically oriented hexagons (8c) packed together to form the core of the multiwall (see FIG. 9D). Alternatively, the slices are folded 180° relative to the origin multiwall and packed in stack formation as explained above. Otherwise, they may be completely cut off from each other and then packed in vertical position relative to their axis of rotation. Thermal treatment and lamination with covers (7a, 7b) are then carried out on the top and bottom surfaces.

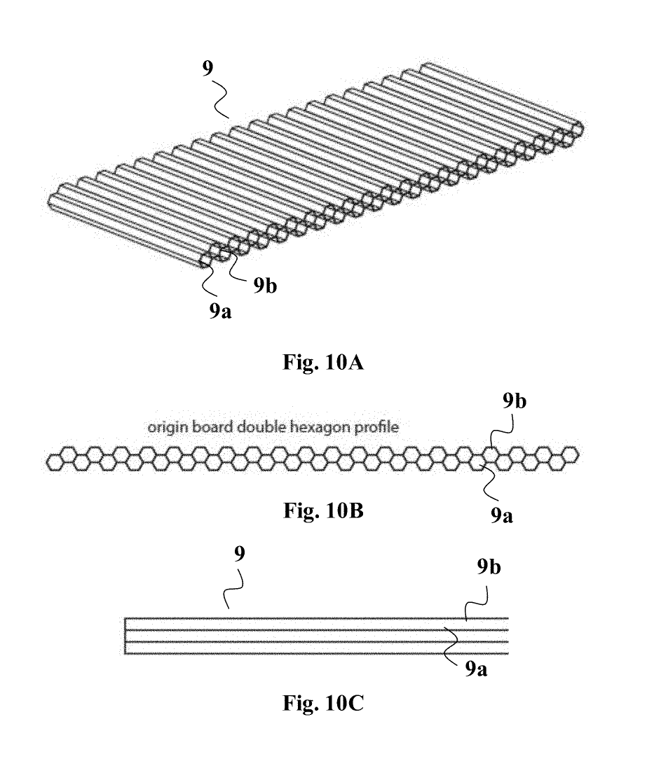

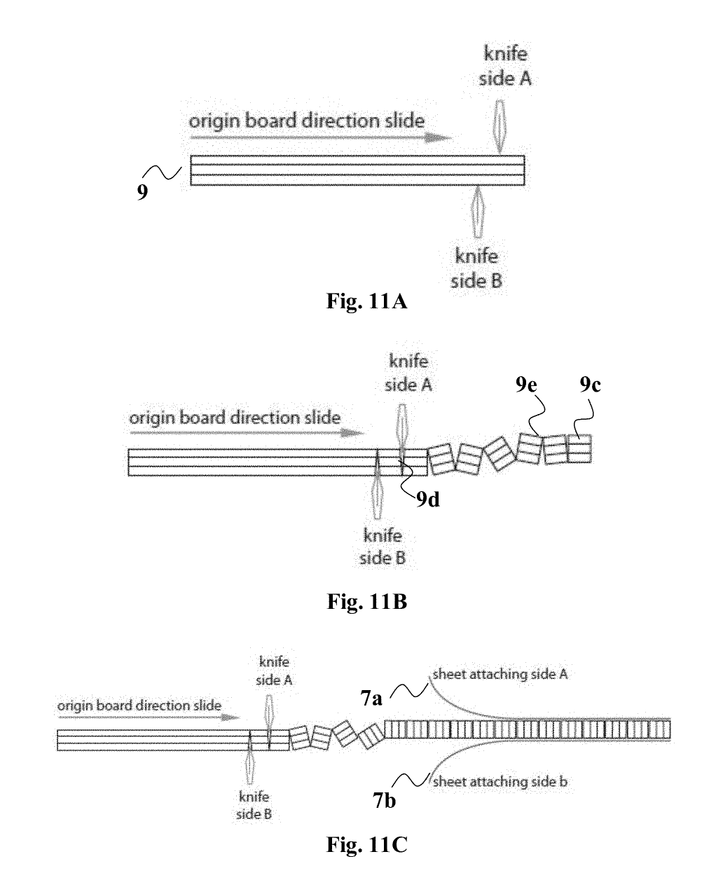

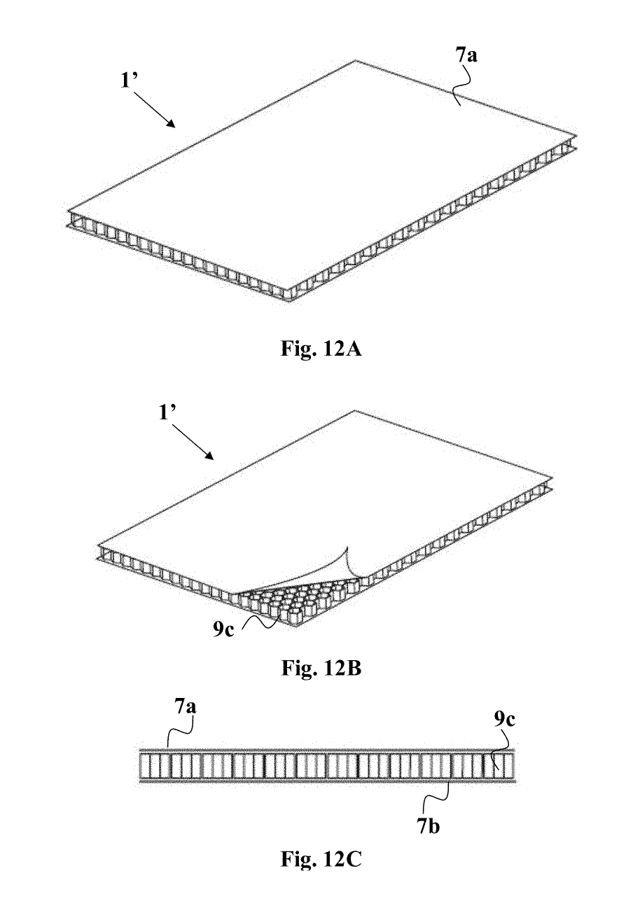

Double layer core of hexagonal flutes (9) is demonstrated in FIGS. 10A-C in which the gap in the lower array of hexagonal flutes (9a) is now occupied with a second layer of hexagonal flutes (9b). The process of manufacturing a vertically oriented core of multiwall (1′) is illustrated in FIGS. 11A-C and essentially the same as the process shown in FIGS. 2A-5B. This time, however, two layers of hexagonal flutes (9a, 9b) are sliced in each cut, folded 90° (clockwise or counterclockwise) around the axis (9e) formed between adjacent slices to form vertically oriented arrays of shortened hexagonal flutes (9c) or 180° towards the origin multiwall in stack packing formation. The two layers now result in fully packed core without gaps between the shortened hexagonal vertical flutes (see FIGS. 12A-C). The top and bottom surfaces of the double-layer hexagonal flutes core are stabilized and laminated to form the double-layer hexagonal vertical multiwall core (see FIGS. 11B-C).

FIG. 15 shows a triple layer core of multiwall with alternating layers of pentagonal and hexagonal flutes. Essentially, the arrangement or layer number of flutes in the core does not affect the method of the present invention for manufacturing multiwalls with vertically oriented core. Therefore, any number of layers of flutes with varying cross sections is well within the scope of the present invention.

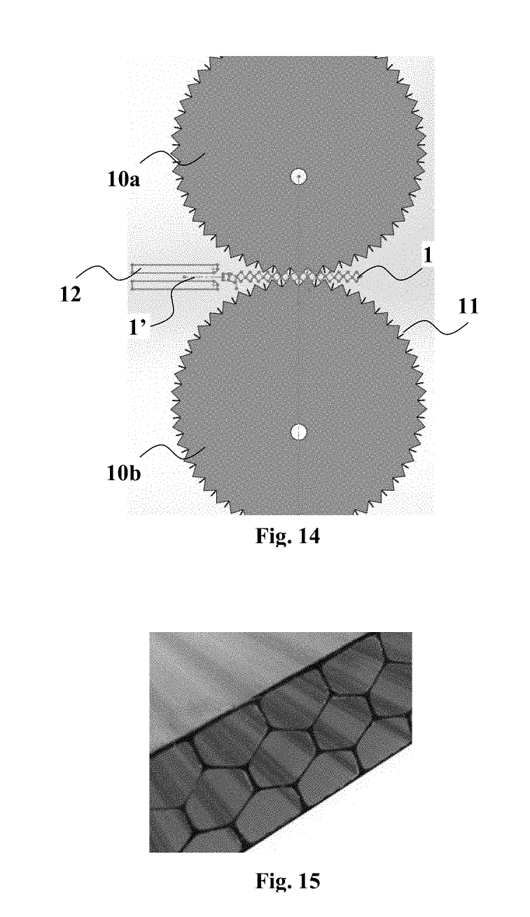

FIG. 14 schematically illustrates front view of particular machine for manufacturing vertically oriented core multiwalls. Two cog-wheels (10a, 10b) are placed beside each other, with their axes or rotation parallel one to the other. Blades (11) are inserted between adjacent teeth of each cog-wheel to cut slices from multiwalls (1) with transversely oriented core that pass between the wheels (10a, 10b). The slices leaving the space between the two wheels (10a, 10b) are then folded 90° or 180° back on the origin multiwall, and processed further with thermal treatment and lamination (12).

It should be noted, that the cross sectional shapes of the flutes described above and illustrated in the accompanying drawings are only examples of the possible shapes of flutes that may be used to form vertically oriented flute core. Therefore, rectangular, circular, parallelogram, octagonal and diamond shapes are other examples that may be used to manufacture vertically oriented cores of multiwalls. Further, transversely oriented cores with more than one layer may be used to manufacture the vertically oriented core of multiwall.

Those skilled in the art to which this invention pertains will readily appreciate that numerous changes, variations and modifications can be made without departing from the scope of the invention mutatis mutandis.

1. A method for manufacturing vertically oriented multiwall core, said method comprising:
(a)providing fluted multiwall or fluted core of multiwall comprising at least one array of transversely oriented flutes;
(b)providing at least one cutting means configured for slicing said array of transversely oriented flutes of said fluted multiwall or fluted core of multiwall;
(c)placing said cutting means in contact with said transversely oriented flutes of said fluted multiwall or fluted core of multiwall at selected distance from first longitudinal edge of at least one surface of said fluted multiwall or fluted core of multiwall;
(d)cutting through a selected thickness of said fluted multiwall or fluted core of multiwall with said cutting means;
(e)generating a slice of said fluted multiwall or fluted core of multiwall;
(f) folding said slice relative said fluted multiwall or fluted core of multiwall or slice previously cut off from said fluted multiwall or fluted core of multiwall;
(g)packing the folded slice with previously folded slices;
(h)repeating steps (c)-(g) until reaching second longitudinal edge parallel said first longitudinal edge of said fluted multiwall or fluted core of multiwall.

2. The method according to claim 1, further comprising:
(i) stabilizing upper and lower surfaces of said vertically oriented multiwall core; and
(j) covering said upper and lower surfaces of said vertically oriented multiwall core.

3. The method according to claim 2, wherein said covering comprises:
placing laminates on upper and lower surfaces of said slices obtained from cutting said transversely oriented flutes of said fluted multiwall or fluted core of multiwall;
applying heating means over said laminates; and
heating said laminates,
wherein said laminates comprising at least two layers, wherein said layers are distinguished one from the other according to their MFIs,
wherein said heating is configured to turn said bottom layer of said laminates to adhesive, said adhesive bonding said laminates to upper and lower surfaces of said slices, wherein WI of said bottom layer is sufficiently low to at least partly melt said bottom layer of said laminates.

4. The method according to claim 3, wherein said upper and lower surfaces of said slices are wavy, indented and/or textured, wherein said adhesive is configured to form mechanical and/or physical bond with said upper and lower surfaces of said slices.

5. The method according to claim 1, wherein folding one slice is done simultaneously with generating second slice.

6. The method according to claim 1, wherein said slice is folded 1800 towards said fluted multiwall provided in stack formation.

7. The method according to claim 1, wherein said slice is folded 900 clockwise or counterclockwise relative a previously cut slice.

8. The method according to claim 1, wherein said cutting is done down to bottom layer of said fluted multiwall.

9. The method according to claim 1, wherein said cutting is done throughout the entire thickness of said fluted multiwall.

10. The method according to claim 1, wherein said at least one cutting means comprises a single cutting means.

11. The method according to claim 1, wherein said at least one cutting means comprises two cutting means, wherein first cutting means is configured to cut through first surface and second cutting means is configured to cut through second surface opposite said first surface of said fluted multiwall or fluted core of multiwall.

12. The method according to claim 1, wherein said cutting means is selected from roller knife, blade knife and cog-wheels comprising blades between adjacent teeth of said cog-wheels.

13. The method according to claim 1, wherein cross section of said transversely oriented flutes is selected from circular, rectangular, pentagonal, hexagonal, octagonal, parallelogram and diamond shapes.

14. The method according to claim 1, wherein said fluted multiwall or fluted core of multiwall comprise a plurality of arrays of transversely oriented flutes.

15. The method according to claim 12, wherein said fluted multiwall or fluted core of multiwall comprise two arrays of hexagonal transversely oriented flutes, wherein one array is layered in gaps between flutes of second array.

16. The method according to claim 12, wherein said fluted multiwall or fluted core of multiwall comprise three arrays comprising pentagonal cross section arrays on top and bottom and hexagonal cross section array in the middle.

17. The method according to claim 1, wherein material from which said fluted multiwall or fluted core of multiwall is made is selected from polypropylene (PP), polyethylene (PE), polyethylenterphthalate (PET), polystyrene (PS) and polycarbonate (PC).

18. The method according to claim 1, wherein said packing is done by mechanically pressing or heat-welding or heat-fusing the slices formed to each other.

19. The method according to claim 2, wherein said stabilizing comprises thermal treatment for leveling said upper and lower surfaces of said vertically oriented core multiwall.

20. The method according to claim 2, wherein said laminating is carried out by heat welding, heat-fusion or gluing.

21. Vertically oriented fluted core of multiwall and multiwall comprising said wall manufactured according to the method as claimed in claim 1.

22. A method for manufacturing vertically oriented multiwall core, said method comprising:
(a) providing fluted multiwall or fluted core of multiwall comprising at least one array of transversely oriented flutes;
(b) providing two cog-wheels comprising blades between each two adjacent teeth of said cog-wheels, said cog-wheels configured for slicing said array of transversely oriented flutes of said fluted multiwall or fluted core of multiwall;
(c) placing said cutting means in contact with at selected distance from first longitudinal edge of at least one surface of said fluted multiwall or fluted core of multiwall;
(d) rolling said cog-wheels over said fluted multiwall while cutting through down to bottom layer of said fluted multiwall or fluted core of multiwall with said blades;
(e) generating a slice of said fluted multiwall or fluted core of multiwall;
(f) folding said slice 1800 in stack formation relative said fluted multiwall or fluted core of multiwall or slice previously cut off from said fluted multiwall or fluted core of multiwall;
(g) repeating steps (c)-(f) until reaching second longitudinal edge parallel said first longitudinal edge of said fluted multiwall or fluted core of multiwall
(h) packing the folded slices with presses applied to top and bottom surfaces of vertically oriented multiwall formed;
(i) stabilizing upper and lower surfaces of said vertically oriented multiwall core; and
(j) covering said upper and lower surfaces of said vertically oriented multiwall core.

23. The method according to claim 22, wherein said covering comprises:
placing laminates on said upper and lower surfaces of said vertically oriented multiwall core obtained from cutting said transversely oriented flutes of said fluted multiwall or fluted core of multiwall;
applying heating means over said laminates; and
heating said laminates,
wherein said laminates comprising at least two layers, wherein said layers are distinguished one from the other according to their MFIs, wherein said heating is configured to turn said bottom layer of said laminates to adhesive, said adhesive bonding said laminates to upper and lower surfaces of said vertically oriented multiwall core, wherein MFI of said bottom layer is sufficiently low to at least partly melt said bottom layer of said laminates.

24. The method according to claim 23, wherein said upper and lower surfaces of said vertically oriented multiwall core are wavy, indented and/or textured, wherein said adhesive is configured to form mechanical and/or physical bond with said upper and lower surfaces of said vertically oriented multiwall core.
